(19) United States
(12) Patent Application Publication
(10) Pub. No.: US 2007/0242585 A1
(43) Pub. Date: Oct. 18, 2007

(54) Playback Device for Optical Storage Discs

(75) Inventor: Adreas Lotz, Asslar-Berghausen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,621

(22) PCT Filed: Jun. 15, 2005
(86) PCT No.: PCT/IB05/51979

§ 371 Date: Dec. 14, 2006

(30) Foreign Application Priority Data
Jun. 25, 2004 (EP) 04102971.1

(51) Int. Cl. G11B 20/10

(52) U.S. Cl. 369/59.11

(57) ABSTRACT

The invention relates to a playback device for optical storage discs (5), which discs comprise each at least one payload data sequence and one information data sequence (TOC), with a read unit (6) for reading the information data sequence of an optical storage disc (5) inserted into the playback device, a memory unit (9), a user interface (8) for generating a copy command, and a control unit (7) with sub-units designed for determining an unequivocal identification (ID1) from the information data sequence of the inserted optical storage disc (5) and for testing registers (V-ID1, V-1D2) present in the memory unit after reception of the copy command and for generating a register characterized by the unequivocal identification if such a register does not yet exist.

The invention relates to a playback device for optical storage discs, which device comprises an additional memory unit into which contents of optical storage discs can be copied. The invention further relates to a method of operating such a playback device.

Playback devices for optical storage discs (in particular audio CDs, CD-ROMs, SACDs, DVDs, etc.) with additional memory units for storing contents of optical memory discs are known. Such playback devices often have a hard disk drive (HDD) as the memory unit, wherein dozens of audio CDs can be copied onto a hard disk, depending on its size. It is also known to provide a playback device with an MP3 stick. Contents of an audio CD are then copied in MP3 coded format onto the flash memory of the MP3 stick, which can be used as a playback device.

Volume, cost, and user-friendliness play an important part in the field of playback devices for optical storage discs, in particular in the automotive field.

It is accordingly an object of the invention to provide a playback device for optical storage discs and a method of operating such a playback device wherein in particular the requirements in the automotive field are satisfied.

The object is achieved by means of a playback device for optical storage discs, which discs comprise each at least one payload data sequence and one information data sequence, with a read unit for reading the information data sequence of an optical storage disc inserted into the playback device, a memory unit, a user interface for generating a copy command, and a control unit with a first sub-unit designed for determining an unequivocal identification from the information data sequence of the inserted optical storage disc, and a second sub-unit designed for testing registers present in the memory unit after reception of the copy command and for generating a register characterized by the unequivocal identification if such a register does not yet exist.

The term “unequivocal” means that an unequivocal identification will take place with a very high probability. It should be allowed for the identification of two optical storage discs to be the same in isolated cases.

The term “read unit” does not exclude the possibility that the read unit may additionally serve for writing an optical storage disc.

The term “sub-unit” denotes both independent processors of the control unit or a permanently wired portion of a processor, or alternatively a software that runs on a processor.

The playback device according to the invention avoids user actions in the creation of registers in the memory unit. Since the invention covers in particular audio devices for the automotive field, the avoidance of user actions is important for an undisturbed concentration of the user on road traffic.

In a further embodiment, the user interface is additionally designed for generating a selection parameter for selecting at least one payload data sequence of the inserted optical storage disc, and the control unit comprises a third sub-unit which after reception of the selection parameter generates an unequivocal designation of the selected payload data sequence, which tests the contents of the register containing the unequivocal identification of the inserted optical storage disc for copies of payload data sequences already present, and controls the read unit into reading of the selected payload data sequence if a copy of the selected payload data sequence does not exist, and also copies the read payload sequence into the register, during which the copy of the payload data sequence is provided with the unequivocal designation.

The term “selection parameter” may relate to individual payload data sequences, but also to a plurality of payload data sequences, or to all payload data sequences present on an optical storage disc. The selection parameter may consist of a single value, of several values, or may have no value at all, depending on the protocol. In the latter case, the absence of an explicit selection parameter may denote the selection of all payload data sequences.

The playback device according to the invention avoids intensive user actions during the process of copying payload data sequences into the memory unit. Since the invention relates in particular to audio devices for the automotive field, the avoidance of user actions is important for an undisturbed concentration of the user on road traffic. The copying expenditure can be reduced to the absolute minimum because the copying process of payload data sequences from the optical storage disc into the register characterized by the unequivocal identification of the inserted optical storage disc takes place according to the invention exclusively if no copy of the selected payload data sequences is present yet.

The copying process should not be regarded as being limited to an exact copy here, but also compression and/or encoding processes in copying should be included herein. The compressed storage of payload data sequences renders it possible to store a particularly large number of payload data sequences in the memory unit. The use of a small memory unit has positive consequences for the cost of the playback device.

The invention also relates to a playback device in which the read unit, the control unit, and the memory unit are arranged in one module of the playback device. This renders possible a compact construction, which is particularly important in view of the requirements imposed in the automotive field, and a flexible arrangement of the exterior of the device, which may be chosen independently of the module.

Furthermore, the unequivocal assignment of payload data sequences by means of the unequivocal designation and the storage in a register characterized by an unequivocal identification render it possible not only to read the payload data sequences from the inserted optical storage disc and the copies of payload data sequences from the memory unit in any order desired for the purpose of playback, but also to give preference to the copies of the payload data sequences in the memory unit over the corresponding payload data sequences on the optical storage disc for the purpose of playback if copies of the payload data sequences of the inserted optical storage disc are present. The use of payload data sequences (the entire memory contents plus the contents of an inserted optical memory disc) is thus made possible also including the memory contents, and the highest possible safeguard against malfunctions in the playback caused by mechanical influences, for example impacts, is achieved.

The invention also relates to a method of operating a playback device for optical storage discs, which discs contain at least one payload data sequence and one information sequence, wherein the playback device has a memory device. The method comprises reading of the information data sequence from an optical storage disc inserted into the playback device and generating an identification, unequivocally assigned to the inserted optical storage disc, from the information data sequence. The method comprises a step, after reception of a copy command, of testing the registers present in the memory unit and creating a new register, if applicable, which is characterized by the identification unequivocally assigned to the inserted optical storage disc, if such a register does not yet exist.

The method furthermore comprises the steps of receiving a selection parameter for selecting a payload data sequence, generating an unequivocal designation of the selected payload data sequence, testing the contents of the register whose identification corresponds to the inserted optical storage disc, and copying the selected payload data sequence from the optical storage disc into the register if no copy of the selected payload data sequence has yet been stored there. After the copying process, the copy of the payload data sequence is provided with the unequivocal designation.

The use of memory chips instead of CD changers renders it possible to reduce the volume of the device, so that the function of a CD changer can be performed in the housing of a normal CD player with the playback device described above. The capacity of the memory chip is a decisive cost question here. The method described in this invention renders possible an unequivocal identification structure with a low memory requirement in comparison with a structure based on the information sequences on the optical storage discs, so that the copying time is reduced through the avoidance of unnecessary copying steps.

The invention will be explained in more detail below with reference to Figures and embodiments. In the drawing:

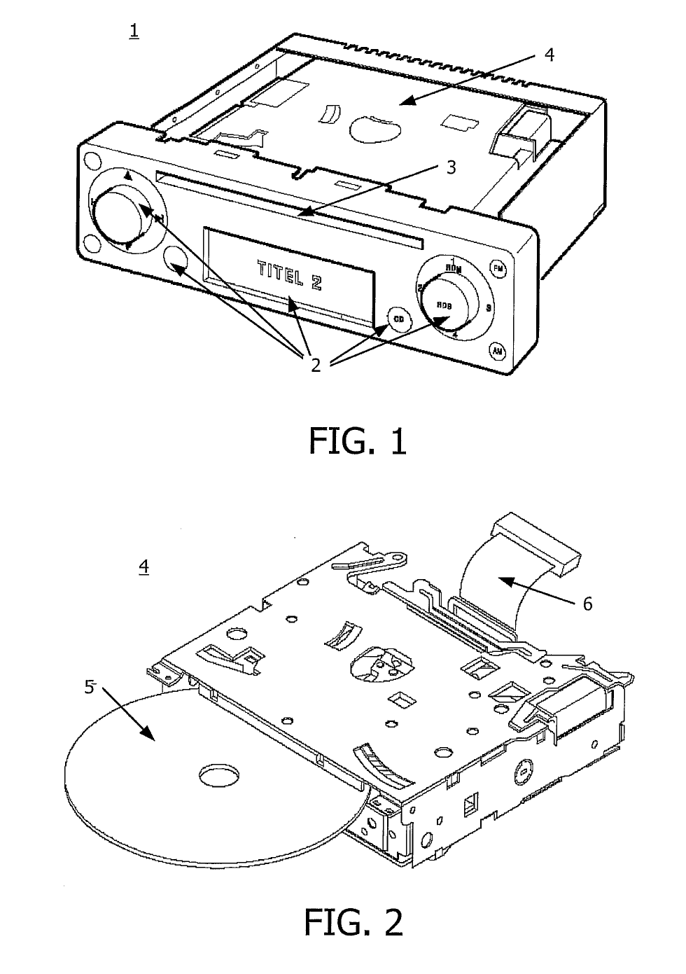

FIG. 1 shows a playback device for optical storage discs,

FIG. 2 shows a storage disc module for use in a playback device for optical storage discs, with an optical storage disc in an insertion or ejection position,

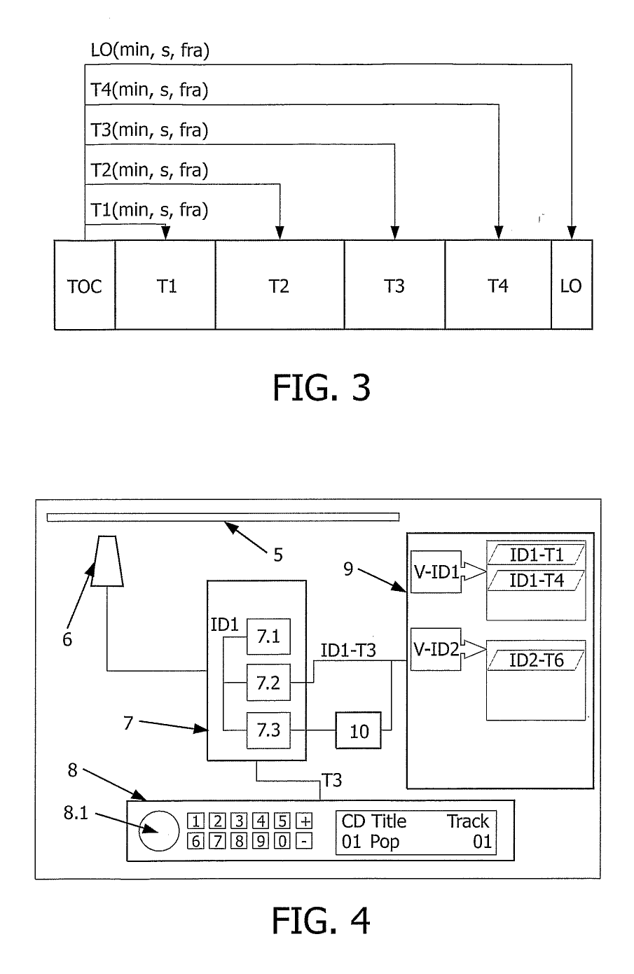

FIG. 3 diagrammatically shows the arrangement of an information data sequence and several payload data sequences of an optical storage disc, using the example of an audio CD (CD-DA),

FIG. 4 shows the internal construction of a playback device for optical storage discs in an embodiment according to the invention, and

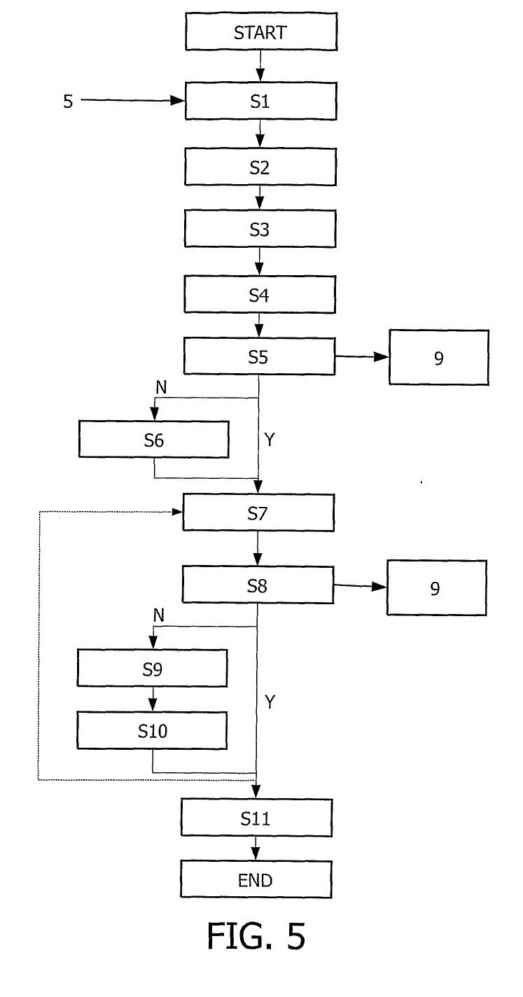

FIG. 5 is a flow chart showing the process steps in operating such a playback device.

FIG. 1 shows a playback device 1 for optical storage discs as is typically used in the automotive field. It has a user interface 2 at the front, shown by way of example here, with various controls and a display by means of which the user is given optical feedback, for example information about the optical storage disc being played or about the contents of a memory unit (cf. FIG. 3). Instead of an optical feedback, an acoustic feedback may obviously also take place, and the user interface may comprise a speech interface or consist thereof. In addition, the playback device 1 has a compartment 3 for inserting or removing optical storage discs. In the embodiment shown, being a playback device for the automotive field, the playback device 1 comprises an outer case with the user interface 2 at the front and a module 4 in which the optical storage discs are played.

FIG. 2 shows a module 4 for playing optical storage discs. An optical storage disc 5 is present in the entrance of the module ready for insertion or removal. The module furthermore has a plug-in connector 6 by means of which the module communicates with the playback device, for example receives commands and transmits information read from an optical storage disc 6 and converted into electronic signals.

An optical storage disc 5 has an information data sequence and at least one payload data sequence. If the optical storage disc is, for example, an audio CD (CD-DA), the information data sequence is the TOC (“Table Of Contents”) of the audio CD, and the payload data sequences are the various audio tracks on the audio CD (i.e. the songs contained thereon). This is diagrammatically shown in FIG. 3. The information data sequence of an audio CD is the so-termed “Table Of Contents” or TOC. The start position of the various audio tracks are contained in the TOC, i.e. by means of indications in minutes (min), seconds (s) and frames (fra), one second comprising 75 frames. This is the actual playing time on the audio CD. The information about the playing time is inserted in between the music information on an audio CD, and the control unit (cf. FIG. 4) of a playback device 1, when looking for a start time, can easily find the corresponding physical position by controlling the read unit. The information data of a TOC are practically an unequivocal fingerprint of a CD. The TOCs of two different audio CDs are identical in very few exceptional cases only. In the example shown in FIG. 3, four payload data sequences T1, T2, T3, T4 are present on the audio CD. The numbers of the individual payload data sequences indicate the sequential numbers denoting the order in which the respective payload data sequences can be found on the optical storage disc. This sequential number (also called track number for audio CDs) unequivocally identifies each payload data sequence. The TOC contains the start information for these four payload data sequences. Furthermore, an audio CD has a lead-out region LO. The start information for this is also present in the TOC. This renders it possible to determine the playing duration for each payload data sequence T1, T2, T3, T4.

FIG. 4 shows an embodiment of a playback device 1 for optical storage discs 5. It comprises a read unit 6 for optical storage discs. Information present on the optical storage disc is read by the read unit 6. The read information is delivered to the control unit 7. The control unit may perform various functions in this respect, for example converting read digital information into electronic signals, which are supplied for playback purposes to a loudspeaker (not shown) after amplification. The control unit 7 is also coupled to a user interface 8. A user interface 8 with a number of controls and a display is shown by way of example. In this embodiment, the user interface 8 also has numerical keys with which, for example, a numbered payload data sequence can be selected from the optical storage disc. The user interface is capable of generating a copy command, for example in that the hatched control 8.1 arranged on the left is pressed.

Furthermore, the playback device 1 has a memory unit 9. Registers ID1 and ID2 are shown by way of example in the memory unit. Two data sets ID1-T1 and ID1-T4 are present in the register ID1, while only one data set ID2-T6 is present in the register ID2.

The control unit 7 in the embodiment shown has three sub-units 7.1, 7.2, and 7.3. The first sub-unit 7.1 is designed for determining an identification that unequivocally characterizes an inserted optical storage disc 5 from the information data set of this optical storage disc 5. For this purpose, the first sub-unit 7.1 uses the information data read by the read unit 6 from the optical storage disc in a first read operation. If the optical storage disc is, for example, an audio CD, the information data sequence will be the TOC (“Table Of Contents”) of the audio CD, which is typically automatically (i.e. controlled by the control unit 7) read by the read unit 6 after insertion of the audio CD and is passed on to the control unit 7. The control unit 7 may comprise a memory (not shown) for retaining the information data, or may store the information data in the memory unit 9. If the optical storage disc is an audio CD, therefore, the unequivocal identification may consist of the CDDB identifier. The CDDB identifier is derived from the TOC and is unequivocally assigned to one audio CD, but for exceptional cases. The CDDB identifier may be used in the case of Internet access for downloading data relating to the inserted audio CD (for example title of the audio CD, artists, titles of the musical numbers) from a database. In the embodiment described, the CDDB identifier is calculated by the first sub-unit 7.1 by means of the known algorithm for determining the CDDB identifier. The CDDB identifier is an eight-digit hexadecimal number here.

The second sub-unit 7.2 now uses the identification (for example ID1) of the optical storage disc for creating a register in the memory unit 9 after reception of a copy command from the user interface 8, which register is characterized by the identification. For this purpose, the second sub-unit 7.2 compares the already existing registers (V-ID1 and V-ID2) as to whether their designations correspond to the identification of the inserted optical storage disc. If there is no register whose designation corresponds to the identifier of the inserted optical storage disc 5, the second sub-unit 7.2 will create a new register with the identification of the inserted optical storage disc 5 as its designation. If there is a register already, for example V-ID1, whose designation corresponds to the identifier ID1 of the inserted optical storage disc 5, no new register will be made. Instead, access is made to V-ID1 for further processes relating to this optical storage disc. Such an automatic procedure avoids intensive user actions via the user interface 8, which has the result in particular in the automotive field that the user can concentrate on the traffic and is not distracted therefrom by the playback device 1. The determination of an identification, for example the CDDB identifier for an audio CD, renders it possible to characterize the registers by means of short, easy-to-handle identifiers which at the same time also have the character of a digital fingerprint of the inserted optical storage disc 5.

The user interface is designed for generating a selection parameter when a copy command is generated via the user interface 8. This selection parameter may also be implicitly determined in that it is concluded from the absence of further data accompanying the copy command that the copy command relates to all payload data sequences of the inserted optical storage disc 5. In other cases, the user selects one, several, or all of the payload data sequences of the inserted optical storage disc, for example by operating keys on the user interfaces and the relevant selected payload data sequences are communicated to the control unit in the form of one, several, or all explicit selection parameters.

After the second sub-unit 7.2 has thus created a new register with the unequivocal identification of the inserted optical storage disc as its designation in the memory unit 9, or has recognized that such a register already exists, it is determined via the selection parameter which payload data sequences of the inserted optical storage disc 5 are to be copied into the register thus determined. The third sub-unit 7.3 controls the read unit 6 such that the corresponding payload data sequences (for example T3) of the inserted optical storage disc 5 should be read and should be copied into the register, which is to be, for example, the already generated register V-ID1 in the ensuing description. The third sub-unit 7.3 generates an unequivocal designation for each payload data sequence during this, in this example ID1-T3, for the copy of the payload data sequence or of the respective optical storage disc from which it is copied. Data structures are then laid out in the register V-ID1 which each correspond to a copy of a payload data sequence and whose designations each unequivocally represent a payload data sequence. In the simplest case, the unequivocal designation is the number in the sequence at which the payload data sequence can be found on the inserted optical storage disc. This is accordingly the so-termed track number on an audio CD. The third sub-unit 7.3 checks before the actual reading and copying process whether a corresponding copy of the payload data sequence already exists in the register V-ID1. If it is determined from the selection parameter, for example, that the payload data sequences with sequence numbers T1 and T3 are to be copied from the inserted optical storage disc 5, the sub-unit 7.3 will check whether the relevant copies have already been made in the register V-ID1. In the present example, copies of the payload data sequences having sequence numbers ID1-T1 and ID1-T4 exist already. The third sub-unit 7.3 accordingly initiates no reading and copying process for the payload data sequence with serial number T1, but only for the payload data sequence with serial number T3. The third sub-unit 7.3 may indicate to the user, for example via an optical feedback on the display, that the payload data sequence T1 is already present in copied form as ID1-T1 and need not be copied anew, but this may also be skipped because the result, i.e. the presence of a copy ID1-T1 of the selected payload data sequence T1 in the memory unit 9 is ensured in any case. The copying process may either generate a 1:1 copy of the payload data sequence in the memory unit, or the payload data sequence is compressed or encoded, with or without losses, in a converter 10, for example by means of an MP3 code or a “High Efficiency AAC” code. These render it possible to use a smaller memory, for example a 128 Mbyte flash memory chip, on which approximately the contents of six audio CDs can be copied with a 32 kbps compression without loss of sound quality, which is suitable for the automotive field. The use of a small memory is a decisive cost factor especially in the automotive field. The small volume of a memory chip can thus achieve the function of a CD changer in the housing of a normal CD player (cf. FIG. 2).

The automatic copying process described above requires no interaction with the user. In particular in the automotive field, the user can thus remain concentrated on the road traffic without being distracted therefrom by necessary interactions with the playback device.

The combination of a read unit 6 for optical storage discs 5 with a memory unit 9 renders it possible to play back the non-stored payload data sequences T2 from the optical storage disc as well as the stored payload data sequences ID1-T1, ID1-T4 in any order desired, for example if the copying process is no longer possible because the memory unit is full. The case may also arise that portions of the payload data sequences T1 of an inserted optical storage disc 5 have already been stored in the memory unit 9 as copies ID1-T1. The playback of the stored copies of the payload data sequences may be given preference so as to reduce the influence of mechanical interferences on the playback thanks to the presence of the identifier ID1 unequivocally assigned to the optical storage disc 5 and the unequivocal designation of the copies of the payload data sequences ID1-T1, ID1-T4.

FIG. 5 shows a procedure for operating a playback device in accordance with what was described above. After the device has been switched on, an optical storage disc is inserted into the playback device in step S1. In step S2, the information data sequence is read from the optical storage disc. In step S3, an unequivocal identification of the optical storage disc is determined from the information data sequence in this embodiment (in the case of an audio CD, for example, the CDDB identifier which is calculated from the data of the TOC). In step S4, a copy command is received, and in step S5 it is tested in the memory unit 9 whether a register having the unequivocal identifier already exists. If this does not exist (indicated by the letter N in the path between S5 and S6, in contrast to the path designated Y, where no register is made because it exists already), a new register having the unequivocal identification is created in the memory unit in step S6. In step S7, the unequivocal designation of the first payload data sequence to be copied is determined on the basis of the (implicitly or explicitly) indicated selection parameters, first of all by means of the unequivocal identification of the optical storage disc determined in step 3 (for example on the basis of the serial numbers of the payload data sequences on the optical storage disc), whereupon it is tested in step S8 whether a copy of the selected payload data sequence exists already in the register characterized by the unequivocal identification. If the register was created in step S6, such a test may obviously be omitted. If a copy of the payload data sequence is in existence, the copying process is skipped (indicated by a Y in the path between step S8 and step S11) otherwise in step S9 the selected payload data sequence is read from the optical storage disc, and in step S10 a copy of the payload data sequence identified by the unequivocal designation is made in the register having the unequivocal identification. This process is repeated from step S7 for all selected payload data sequences (indicated by a dotted line). In step 11, a return message is given to the user in the embodiment discussed here by way of example, for example acoustically by means of a speech message “copying process completed” or the like. This ends the procedure. The optical storage disc may be removed or may remain in the read unit for the reproduction of payload data sequences. After removal, a different optical storage disc may be inserted for a further copying process or for the playback of payload data sequences. Alternatively, a copy of the payload data sequences may be read from the memory unit and may be reproduced (for example via a loudspeaker in the case of an audio payload data sequence). The payload data sequences may be stored non-compressed or compressed/encoded in the copying process.

1. A playback device for optical storage discs (5), which discs comprise each at least one payload data sequence (T1, T2, T3, T4) and one information data sequence (TOC), with
a read unit (6) for reading the information data sequence (TOC) of an optical storage disc (5) inserted into the playback device,
a memory unit (9),
a user interface (8) for generating a copy command, and
a control unit (7) with
a first sub-unit (7.1) designed for determining an unequivocal identification (ID1) from the information data sequence (TOC) of the inserted optical storage disc (5), and
a second sub-unit (7.2) designed for testing registers (V-ID1, V-ID2) present in the memory unit after reception of the copy command and for generating a register characterized by the unequivocal identification if such a register does not yet exist.

2. A playback device as claimed in claim 1, characterized in that
the user interface (8) is additionally designed for generating a selection parameter for selecting at least one payload data sequence (T1, T2, T3, T4) of the inserted optical storage disc (5), and
the control unit (7) comprises a third sub-unit (7.3) which after reception of the selection parameter is designed to
generate an unequivocal designation of the selected payload data sequence (ID1-T3),
to test the register (V-ID1) having the unequivocal identification of the inserted optical storage disc (5) for copies of payload data sequences (ID1-T1, ID1-T4) already present, and
if a copy of the selected payload data sequence does not exist, to control the read unit (6) into reading of the selected payload data sequence (T3) and into copying of the read payload sequence into the register (V-ID1), during which the copy of the payload data sequence is provided with the unequivocal designation (ID1-T3).

3. A playback device as claimed in claim 1, characterized in that the playback device comprises a converter (10) which compresses and/or encodes a payload data sequence during copying.

4. A playback device as claimed in claim 1, characterized in that the read unit (6), the control unit (7), and the memory unit (9) are arranged in one module of the playback device.

5. A playback device as claimed in claim 1, characterized in that the control unit (7) accesses the read unit (6) and the memory unit (9) for a selective playback of payload data sequences such that the payload data sequences (T2, T3) on the inserted optical storage disc (5) and the copies of the payload data sequences (ID1-T1, ID1-T4, ID2-T6) in the memory unit (9) are reproduced in any sequence desired.

6. A playback device as claimed in claim 5, characterized in that the control unit (7) uses the copy of the payload data sequence (ID1-T3) in the memory unit (9) in preference to the corresponding original payload data sequence (T3) on the optical storage disc (5) for a selective playback of payload data sequences.

7. A method of operating a playback device (1) for optical storage discs (5) which contain at least one payload data sequence (T1, T2, T3, T4) and an information sequence (TOC), wherein the playback device (1) comprises a memory unit (9), and the method comprises the following steps:
reading of the information data sequence (TOC) from an optical storage disc (5) inserted into the playback device (1),
generating an identifier (ID1) unequivocally assigned to the inserted optical storage disc (5) from the information data sequence (TOC),
receiving a copy command,
testing registers (V-ID1, V-ID2) present in the memory unit (9), and
creating a new register (V-ID1) characterized by the identifier (ID1) that is unequivocally assigned to the inserted optical storage disc (5), if such a register does not yet exist.

8. A method as claimed in claim 7, characterized in that it further comprises:
receiving a selection parameter that selects at least one payload data sequence (T3),
generating an unequivocal designation for the selected payload data sequence (T3),
testing the contents of the register (V-ID1) having the identifier that is unequivocally assigned to the inserted optical storage disc (5),
copying the selected payload data sequence (T3) from the inserted optical storage disc (5) into the register (V-ID1), if no copy of the selected payload data sequence (T3) is stored therein, said copy of the payload data sequence (ID1-T3) being given the unequivocal designation.
